(19) United States
(12) Patent Application Publication
(10) Pub. No.: US 2026/0132000 A1
(43) Pub. Date: May 14, 2026

(54) LATCH ASSEMBLY FOR LIFTING DEVICES, CAM PINS THEREFOR, LIFTING DEVICES EQUIPPED THEREWITH, AND METHODS OF OPERATION

(71) Applicant: Marc Pentecost, Valparaiso, IN (US)

(72) Inventor: Marc Pentecost, Valparaiso, IN (US)

(21) Appl. No.: 19/386,969

(22) Filed: Nov. 12, 2025

Related U.S. Application Data
(60) Provisional application No. 63/719,311, filed on Nov. 12, 2024.

(51) Int. Cl. B66C 1/48

(52) U.S. Cl. CPC B66C 1/485

(57) ABSTRACT

Latch assemblies for locking assemblies of lifting devices, cam pins for locking assemblies of lifting devices, lifting devices, and methods for their operation. Such a locking assembly includes a cam pin with a circumferential cam path extending continuously around its entire outer diameter. The cam path has a plurality of successive saw-tooth sections, each of which has an axial portion aligned parallel to a longitudinal axis of the cam pin and a slanted portion aligned at an angle to the longitudinal axis. A retractable pawl forms an upper end of the slanted portion of the cam path and retracts radially inwardly when the follower pin travels upwardly along the axial portion into the upper junction. A biasing mechanism automatically urges the retractable pawl radially outwardly toward the extended configuration such that the pawl prevents the follower pin from traveling back downwardly along the axial portion from the upper junction.

### CROSS-REFERENCE TO RELATED APPLICATIONS

This application claims the benefit of provisional U.S. Patent Application No. 63/719,311 filed Nov. 12, 2024, the contents of which are incorporated herein by reference.

### BACKGROUND OF THE INVENTION

The invention generally relates to locking assemblies, such as may be used for lifting devices, and methods of operating such locking assemblies. The invention is particularly directed to latch assemblies for locking assemblies on coil lifting devices, coil lifting devices equipped therewith, components of such latch assemblies, and methods for operating coil lifting devices.

Coil lifting devices are used in the steel industry to lift and move steel coils, stacks of steel plates, steel ingots, and other types of very large, very heavy items. Common names for such devices include vertical coil tongs (VCT), Heppenstall coil lifting devices, Heppenstall coil tongs, and Heppenstalls. Conventional coil lifting devices operate through a geometric design including a scissors linkage that carries a pair of tongs adapted to squeeze a steel coil between the center (eye) of the coil and the outer diameter of the coil, with friction as the main engagement and gripping force. Under the gravity load of the coil and the coil lifting device itself, the tongs cinch tight to the coil so that it may be lifted and moved to a different location. An example of a coil lifting device is disclosed in U.S. Pat. No. 3,037,806, the contents of which are incorporated herein by reference.

A typical feature of conventional coil lifting devices is a locking/unlocking mechanism that makes it possible for a crane operator to automatically lock and/or unlock the tongs of the device to a load simply through the up and down motion of the tongs relative to the load. A typical conventional coil lifting device is designed in such a way that no external operations are needed to attach or remove the lift device from the coil. All engagements are accomplished by the crane operator utilizing lifting (raising) and lowering movements. Such a design permits a coil lifting device to be placed on a coil and, through a lifting and lowering movement of the device, rotationally index a cam pin along a set of radial cams between an unlocked position in which the scissors linkage is unlocked and allowed to expand in a scissor-like movement from a retracted configuration to an extended configuration during which the tongs move toward each other from an open configuration toward a closed configuration so that the tongs are able to grip a coil therebetween, and a locked position in which the scissors linkage are locked in the retracted configuration with the tongs locked in their open configuration so that the tongs are able to release a coil that had been gripped therebetween. An example of a conventional latch mechanism assembly for this operation is disclosed in U.S. Pat. No. 2,776,857, the contents of which are incorporated herein by reference.

When a coil is ready to be loaded for transport to a different location, an empty coil lifting device is lowered onto the coil and the locking/unlocking mechanism is indexed by the crane operator to move the cam pin from its locked position to its unlocked position. When the cam pin is in its unlocked position, the scissors linkage is able to expand from its retracted configuration to its extended configuration to cinch/clamp the tongs onto the coil between the inside (eye) of the coil and the outside diameter of the coil. When it is desired to remove the lifting device from the coil, the crane operator locks the coil lifting device in the retracted configuration by again lowering the coil lifting device onto the coil to index the cam pin to rotate to the locked position, which prevents the scissors linkage from expanding from its retracted configuration to its extended configuration as the lifting device is raised off the coil.

The cam pin floats in a cylindrical chamber of a cam pin housing and has an annular cam path that forces the direction of the cam pin rotation. The cam pin is nested between two fixed cam followers that are fixed to the cam pin housing. The cam pin floats both vertically (axial translation) and cylindrically (axial rotation) in its cylindrical chamber, and the lower end of the cam pin has a T-latch, which successively engages and disengages a latching block. When the T-latch is engaged in the latching block, the coil lifting device is locked open and can be removed from the coil. Likewise, when the T-latch is disengaged in the latching block, the coil lifting device is unlocked, allowing the scissors linkage to expand and squeeze the tongs together to grab the coil through its cinching geometry.

A challenge with conventional locking/unlocking mechanisms on conventional coil lifting devices is a condition called “false latch,” in which the cam pin does not fully index from the unlocked position into the locked position. The false latch condition can possibly lead to unexpected and undesirable release of the locking/unlocking mechanism and extension of the scissors linkage. In one known locking assembly, the coil lifting device must be lifted and lowered twice to rotate the cam pin 90 degrees. The design uses an offset cam path along the outer diameter of the cam pin in which the upper and lower cam paths are offset 45 degrees. To rotate the cam pin, the coil lifting device must be lifted once to index the cam pin 45 degrees, then lowered to index the second 45 degrees, and then lifted a second time to set the cam pin in either the locked or unlocked position within the latching block, 90 degrees from the original starting location. Each 90-degree rotation successively either locks or unlocks the cam pin in the latching block. However, this design allows an undesirable operating variability in actuating the cam pin. The cam paths permit too much clearance between the cam surfaces and the cam followers, which can cause a problem indexing the cam pin when the lifting and lowering cycles are completed. Because of this, the cam pin can achieve a false latch, where the cam pin does not fully engage the latching block, as it does not complete the 90-degree rotation required to lock the T-latch in the latching block. As a result, the cam pin will engage the latching block enough that it will partially lock but can vibrate free through crane movement. A falsely latched cam pin typically only engages about 15% of the latching block, just enough to allow the tongs to release from the coil. When this happens, the combination of the false latch, crane vibration, and the large cam clearances can allow the cam pin to rotate backwards and unlock the scissors linkage, thereby leading to sudden and unexpected expansion of the scissors linkage.

Therefore, it would be desirable to have a locking assembly for a coil lifting device that can eliminate a false latch scenario that can result in unexpected unlocking of the scissors linkage.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, latch assemblies for locking assemblies on coil lifting devices, coil lifting devices equipped therewith, cam pins for such latch assemblies, and methods for operating coil lifting devices.

According to a nonlimiting aspect, a latch assembly for a locking assembly on a coil lifting device includes a cam pin housing comprising a bore, a follower pin fixed to the cam pin housing and extending into the bore, and a cam pin disposed within the bore. The cam pin can slide axially and rotationally within the bore. The cam pin may include a locking head disposed toward a bottom end of a main body, a cam head disposed toward a top end of the main body, and a circumferential cam path extending continuously around an entire outer periphery of the cam head and slidably receiving the follower pin therein. The cam path may have a plurality of successive saw-tooth sections. Each saw-tooth section may have an axial portion of the cam path aligned parallel to a longitudinal axis of the cam pin and a slanted portion of the cam path aligned at an angle to the longitudinal axis. An upper end of each of the axial portion and the slanted portion of a saw-tooth section may intersect with each other at an upper junction. A lower end of the slanted portion of one saw-tooth section may intersect with a lower end of the axial portion of the next adjacent saw-tooth section at a lower junction. A retractable pawl may extend into the cam path adjacent the upper junction. The retractable pawl may form at least a portion of the upper end of the slanted portion of the cam path in an extended configuration. The retractable pawl may retract radially inwardly toward the longitudinal axis of the cam pin when the follower pin travels upwardly into and past the retractable pawl. A biasing mechanism may automatically urge the pawl radially outwardly toward the extended configuration. The retractable pawl may prevent the follower pin from traveling downwardly along the axial portion from the upper junction when in the extended configuration.

According to another nonlimiting aspect, a cam pin for a locking assembly on a coil lifting device includes an elongate main body extending along a longitudinal axis between a cam head and a locking head for latching to the latching block, and a circumferential cam path extending continuously around an entire outer periphery of the cam head for slidably receiving a follower pin therein. The cam path may have a plurality of successive saw-tooth sections. Each saw-tooth section may include an axial portion of the cam path aligned parallel to the longitudinal axis and a slanted portion of the cam path aligned at an angle to the longitudinal axis. An upper end of each of the axial portion and the slanted portion of a saw-tooth section may intersect with each other at an upper junction. A lower end of the slanted portion of one saw-tooth section may intersect with a lower end of the axial portion of the next adjacent saw-tooth section at a lower junction. A retractable pawl may extend into the cam path adjacent the upper junction. The retractable pawl may form at least a portion of the upper end of the slanted portion of the cam path in an extended configuration. The retractable pawl may retract radially inwardly toward the longitudinal axis of the cam pin in response to a follower pin traveling upwardly into and past the retractable pawl. A biasing mechanism may automatically urge the pawl radially outwardly toward the extended configuration. The pawl may prevent a follower pin from traveling downwardly along the axial portion from the upper junction when in the extended configuration.

According to yet another nonlimiting aspect, a coil lifting device includes a scissors linkage that articulates from an extended configuration to a retracted configuration, a pair of tongs coupled to the scissors linkage and configured to clamp and unclamp in response to extension and retraction of the scissors linkage, and a locking assembly for automatically locking the scissors linkage in the retracted configuration. The locking assembly may include a cam pin housing with a bore attached to a link of the scissors linkage, follower pin fixed to the cam pin housing and extending into the bore, and a cam pin disposed within the bore and able to slide axially and rotationally within the bore. The cam pin may include a locking head disposed toward a bottom end of a main body, a cam head disposed toward a top end of the main body, a circumferential cam path extending continuously around an entire outer diameter of the cam head and slidably receiving the follower pin therein, and a retractable pawl extending into the cam path adjacent the upper junction. The cam path may have a plurality of successive saw-tooth sections, each saw-tooth section including an axial portion of the cam path aligned parallel to a longitudinal axis of the cam pin and a slanted portion of the cam path aligned at an angle to the longitudinal axis. An upper end of each of the axial portion and the slanted portion of a saw-tooth section may intersect with each other at an upper junction. A lower end of the slanted portion of one saw-tooth section may intersect with a lower end of the axial portion of the next adjacent saw-tooth section at a lower junction. The retractable pawl may form at least a portion of the upper end of the slanted portion of the cam path in an extended configuration. The retractable pawl may retract radially inwardly toward the longitudinal axis of the cam pin when the follower pin travels upwardly into and past the retractable pawl. A biasing mechanism automatically urges the retractable pawl radially outwardly toward the extended configuration. The retractable pawl may prevent the follower pin from traveling downwardly along the axial portion from the upper junction when in the extended configuration. The locking assembly may further include a latching block for latching to the cam pin. The latching block may be secured to another section of the scissors linkage to engage against the bottom end of the cam pin when the scissors linkage is in a retracted configuration and to disengage from the bottom end of the cam pin when the scissors linkage is in an extended configuration. The locking head can rotate to a locked position to the latching block when the cam pin is indexed by raising away from and subsequently lowering back onto the latching block. The locking head can rotate from the unlocked position to an unlocked position to the latching block the next time the cam pin indexed by raising away from and subsequently lowering back onto the latching block.

According to a further nonlimiting aspect, a method of operating a coil lifting device comprising a latch assembly as described above is provided. The method includes, lowering the coil lifting device a first time, thereby rotating the cam pin a first time to a locked position, raising the coil lifting device a first time with the cam pin remaining in the locked position, lowering the coil lifting device a second time, thereby rotating the cam pin a second time to an unlocked position, and raising the coil lifting device a second time with the cam pin remaining in the unlocked position.

Technical aspects of latch assemblies, cam pins, coil lifting devices, and methods as described above include the capability of preventing or at least reducing the risk of the phenomenon of false latching that can be encountered with a conventional coil lifting device.

These and other aspects, arrangements, features, and/or technical effects will become apparent upon detailed inspection of the figures and the following description.

### BRIEF DESCRIPTION OF THE DRAWINGS

FIG. 1 is a perspective view of a coil lifting device with a locking assembly according to an embodiment of the present invention in a locked configuration.

FIG. 1A is an enlarged view of the circled portion of FIG. 1 showing the locking assembly.

FIG. 2 is a perspective view of the coil lifting device of FIG. 1 in an unlocked configuration and loaded with a coil for transport.

FIG. 3 is a perspective view of the locking assembly according to an embodiment of the present invention with exterior portions shown in phantom to allow visualization of internal features.

FIG. 4 is a perspective view of internal components of the locking assembly of FIG. 3 including a cam pin, cam follower pins, and keeper plates.

FIG. 5 is an enlarged axial cross-sectional view of the cam pin, follower pins and keeper plates, and in addition pawls that operate in combination with the follower pins.

FIG. 6 is a bottom view of a T-latch of the cam pin operationally disposed in a latching block of the coil lifting device in an unlocked position.

FIG. 7 shows the T-latch of the cam pin and latching block of FIG. 6 in a locked position.

FIG. 8 shows an alternative configuration for the pawls depicted in FIG. 5.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Although the invention will be described hereinafter in reference to a lifting device 10 shown in the drawings as adapted to lift a steel coil 200 (FIG. 2), it will be appreciated that the teachings of the invention are more generally applicable to a variety of types of lifting devices, particularly those that utilize tongs to lift an object.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the coil lifting device 10 and a locking assembly 100 thereof during use and/or as represented in the drawings. All such relative terms are useful to describe the illustrated embodiment(s) but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

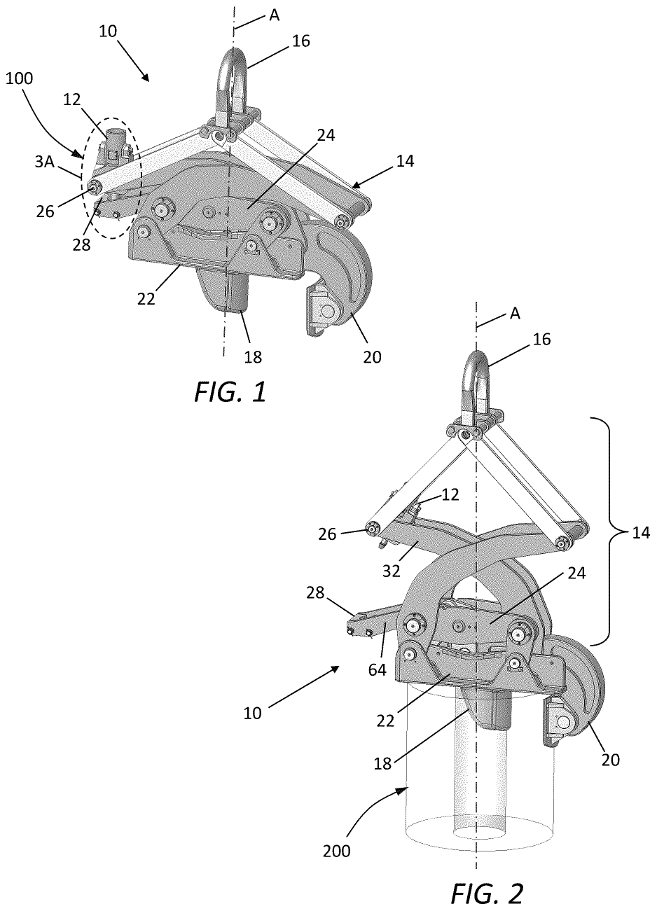

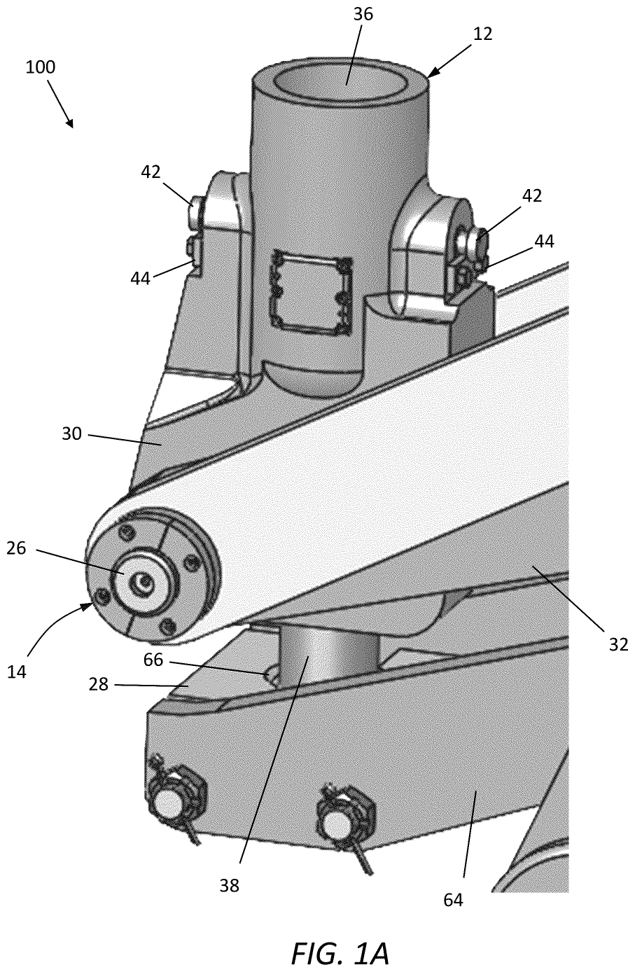

Turning now to nonlimiting embodiments represented in the drawings, FIGS. 1, 1A, and 2 depict the coil lifting device 10 and locking assembly 100, with the latter having a latch assembly 12 for automatically locking the coil lifting device 10 in a locked configuration shown in FIG. 1 and unlocking the coil lifting device 10 to allow the device 10 to articulate to an unlocked configuration shown in FIG. 2. The coil lifting device 10 further includes a scissors linkage 14 that expands/extends and contracts/retracts along a longitudinal extension/retraction axis A between the locked configuration of FIG. 1 in which the scissors linkage 14 has been collapsed/retracted to arrive at a retracted configuration and the unlocked configuration of FIG. 2 in which the scissors linkage 14 has been expanded/extended to arrive at an extended configuration. A lift hitch 16 is coupled to the top end of the scissors linkage 14 from which a crane hook or other apparatus can attach to and raise the entire coil lifting device 10. A pair of generally vertically oriented clamping tongs 18 and 20 extend downwardly from the bottom end of the scissors linkage 14 and are configured to move toward and away from each other in a lateral direction relative to the axis A in response to extension and retraction of the scissors linkage 14. One of the tongs, referred to herein as the center tong 18, is coupled to a first horizontal cross link 22 extending laterally across the lower end of the scissors linkage 14. The other tong, referred to herein as the outer tong 20, is coupled to a second horizontal cross link 24 also coupled to the lower end of the scissors linkage 14 directly above the first horizontal cross link 22. The horizontal cross links 22 and 24 are coupled to the scissors linkage 14 in such a way that when the scissors linkage 14 extends (transitioning from FIG. 1 to FIG. 2) the horizontal cross links 22 and 24 shift laterally toward the axis A and in opposite directions so that the tongs 18 and 20 travel toward each other thereby decreasing the distance between the tongs 18 and 20, and when the scissors linkage 14 retracts (transitioning from FIG. 2 to FIG. 1) the horizontal cross links 22 and 24 shift laterally away from the axis A and in opposite directions so that the tongs 18 and 20 travel away from each other thereby increasing the distance between the tongs 18 and 20.

While the following description will focus on the lifting device 10 illustrated in the drawings as adapted to be able to grip and lift a steel coil 200 as represented in FIG. 2, it is understood that other configurations of the coil lifting device 10 may be configured to secure and lift other types of loads, such as ingots, stacked plates, sheets, beams, or almost any other type of heavy load. Further, in some embodiments the tongs 18 and/or 20 may include in-turned arms that also engage underneath a horizontal surface of a load to directly support the load, either in addition or alternatively to securing the load with clamping frictional forces. Thus, it is understood that the term “coil” in the name “coil lifting device” does not limit the invention to lifting devices that are only designed for lifting a coil, such as a steel coil.

The latch assembly 12 is carried by the scissors linkage 14 near the end of a link at the next linkage joint 26 immediately above the horizontal cross link 24. The locking assembly 100 further includes a latching block 28 is coupled to the horizontal cross link 24 by an arm so as to be disposed immediately opposite and facing the latch assembly 12 when the scissors linkage 14 is collapsed/retracted to the retracted configuration. In this way, when the scissors linkage 14 is fully retracted, such as when a crane lowers the coil lifting device 10 holding a coil to the ground, the latch assembly 12 will engage the latching block 28 and index a rotational latch to engage the latching block 28 in a locked position with the scissors linkage 14 retracted, as shown in FIG. 1. In the locked position, the latch assembly 12 locks to the latching block 28, which prevents the scissors linkage 14 from extending when the coil lifting device 10 is next raised at the lift hitch 16, such as when the coil lifting device 10 is to be maneuvered to clamp onto another coil or other load. The next time the coil lifting device 10 is lowered onto a coil or other load or support, the latch assembly 12 again engages the latching block 28 and indexes the rotational latch to an unlocked position. In this unlocked position, the rotational latch disengages from the latching block 28 so that when the coil lifting device 10 is next raised, the scissors linkage 14 can extend, thereby causing the tongs 18 and 20 to travel toward each other and in so doing able to clamp and grip a new load therebetween for lifting and moving.

As seen in FIGS. 1, 1A, and 2, the latch assembly 12 is fixedly attached to the scissors linkage 14 so as to articulate with the scissors linkage 14. The latch assembly 12 includes a cam pin housing 30 that is fixedly secured to a lower link 32 of the scissors linkage 14, for example with one or more bolts, pins, welds, or other fasteners. In this example, the cam pin housing 30 includes two mounting holes 34 for securing the latch assembly 12 to the linkage 14. A link pin of the linkage joint 26 extends through one of the mounting holes 34, and a second mounting pin secured to the link 32 extends through the other mounting hole 34. A generally cylindrical bore 36 extends through the cam pin housing 30 in a generally vertical direction (for example, perpendicular to the axis of the mounting holes 34) for slidably receiving a cam pin 38. The cam pin 38 can slide inside the bore 36 both in translation axially along the bore axis (e.g., up and down) and in rotation about the bore axis.

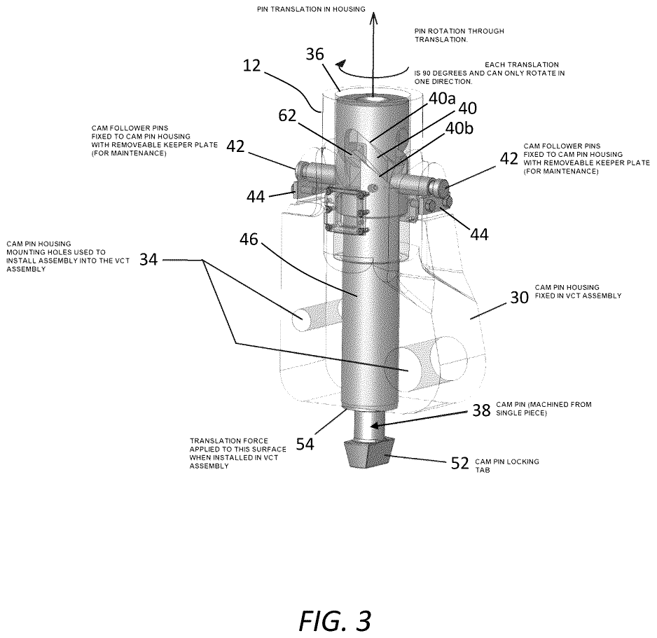

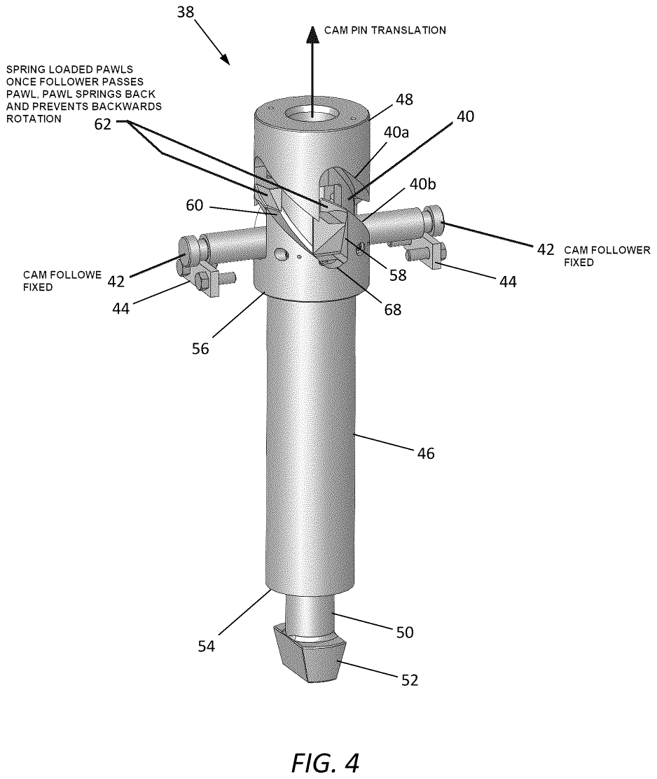

As seen in FIGS. 3 and 4, the cam pin 38 includes a cylindrical main body 46, a generally cylindrical cam head 48 disposed at the top end of the main body 46, a cylindrical neck 50 disposed at the bottom end of the main body 46, and a locking head 52 disposed at the lower end of the neck 50. The neck 50 has a smaller outside diameter than the main body 46, and a radial lower stepped shoulder 54 is formed at the interface between the main body 46 and the neck 50. The cam head 48 has an outside diameter that is larger than the outside diameter of the main body 46, and a radial upper stepped shoulder 56 is formed at the interface between the main body 46 and the cam head 48. The locking head 52 has a generally rectangular oblong shape, represented as a trapezoidal prism shape having a lateral width approximately the same as the outer diameter of the neck 50 and a lateral length longer than its lateral width to define what is referred to herein as a T-shaped latch with two locking tabs on opposite lengthwise ends of the latch. For example, the lateral length may be approximately the same as or less than the outside diameter of the main body 46. In addition, the locking head 52 is represented as tapered in the axial direction such that the top end of the locking head 52 is wider in both the lateral width and lateral length directions than the corresponding dimensions at the bottom end of the locking head 52. The opposite lateral ends of the locking head 52 that form the locking tabs may be arcuate, for example, to follow or otherwise generally correspond to the outer diameter of the main body 46.

The cam pin 38 includes a pair of opposing zig-zag shaped upper and lower cam surfaces 40a and 40b that, together, form a zig-zag shaped cam path 40 therebetween extending around an outer circumference of the cam pin 38. Two cam follower pins 42 are fixedly mounted to the cam pin housing 30. The follower pins 42 are axially aligned with each other and extend inwardly from opposite sides of the cam pin housing 30 such that the interior ends of the follower pins 42 are spaced apart from each other and disposed in the cam path 40 on opposite sides of the cam pin 38 to slidingly engage the upper and lower cam surfaces 40a and 40b. The follower pins 42 may be secured to the cam pin housing 30 with removable keeper plates 44 to allow for selective removal of the cam follower pins 42, for example, for maintenance or replacement. The cam path 40 forms a zig-zag groove extending around the outer circumference of the cam head 48 defined by and between the upper cam surface 40a and the lower cam surface 40b. The upper and lower cam surfaces 40a and 40b are substantially parallel with each other on opposite sides of the cam path 40 and are spaced apart a distance approximately equal to or slightly larger than the diameters of the ends of the follower pins 42 that are disposed between the cam surfaces 40a and 40b and travel along the cam path 40. In this embodiment, the cam path 40 is configured to cause the cam pin 38 to rotate axially 90° within the bore 36 of the cam pin housing 30 each time the cam pin 38 is translated axially up within the bore 36 the entire axial amplitude of the zig-zag cam path 40. In this example, the cam path 40 has four connected saw-tooth sections oriented at 90° intervals around the outer circumference of the cam head 48. Each saw-tooth section of the cam path 40 has an axial portion 58 that is aligned generally parallel with the axis of the cam pin 38 and a slanted (e.g., helical) portion 60 that extends from the top end of the axial portion 58 at an angle to the pin axis down to the bottom of the next adjacent axial portion 58. The four axial portions 58 are spaced apart axially at 90° intervals around the outer surface of the cam head 48, and each slanted portion 60 extends in the same direction (in this example, counterclockwise as viewed looking down on the top end of the cam head 48) an angular sweep of 90°.

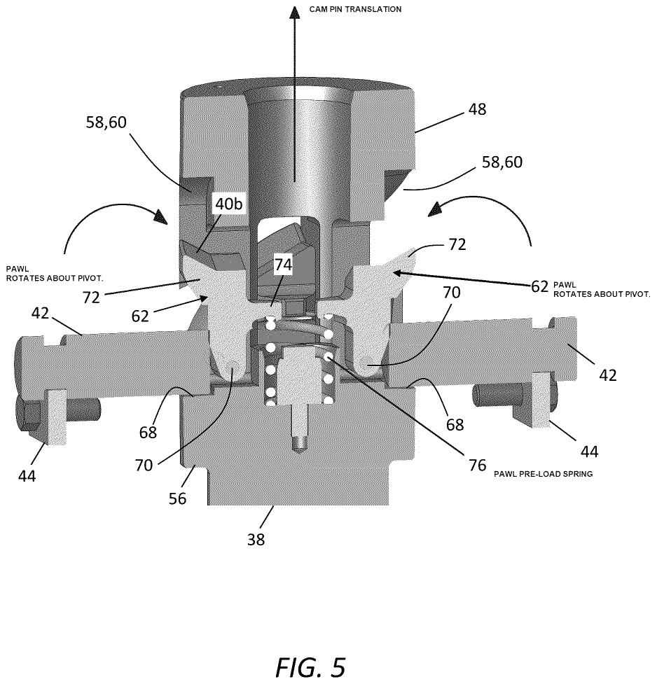

As best seen in FIGS. 4 and 5, each saw-tooth section of the cam path 40 includes a radially outwardly biased pawl 62 disposed at the intersection of the top of the axial portion 58 and the respective slanted portion 60 to prevent the follower pins 42 from traveling downwardly (toward the locking head 52) along the axial portion 58 after having reached the top of the axial portion 58. When in its extended configuration, the pawl 62 defines the upper end of the lower cam surface 40b of the slanted portion 60. The pawl 62 retracts radially inwardly toward the axis of the cam pin 38 from the extended configuration when the follower pin 42 travels upwardly to the top of the axial portion 58 to allow the follower pin 42 to travel into the top end of the slanted portion 60. When the follower pin 42 has completely passed upwardly by the pawl 62 into the upper junction space defining the combined top ends of both the axial portion 58 and the respective slanted portion 60 of the cam path 40, the pawl 62 automatically extends radially back outwardly to the extended configuration to prevent the follower pin 42 from moving back down into the axial portion 58 of the cam path 42. Thus, when the follower pin 42 next moves radially downwardly toward the locking head 52, the pawl 62 forces the cam pin 38 to follow the lower cam surface 40b of the slanted portion 60 down to the bottom end of the next adjacent axial portion 58. This simultaneously forces the cam pin 38 to rotate axially 90° within the bore 36 of the cam pin housing 30, thereby indexing the cam pin 38 and the locking head 52 a quarter rotation to the next successive locked or unlocked position relative to the latching block 28. This process is repeated each time the cam pin 38 is fully indexed within the cam pin housing 30 as the follower pins 42 advances along the cam path 40 around the entire circumference of the cam head 48, thereby allowing the cam pin 38 to incrementally rotate quarter circle rotations in the same angular direction every time the cam pin 38 is indexed, essentially ad infinitum.

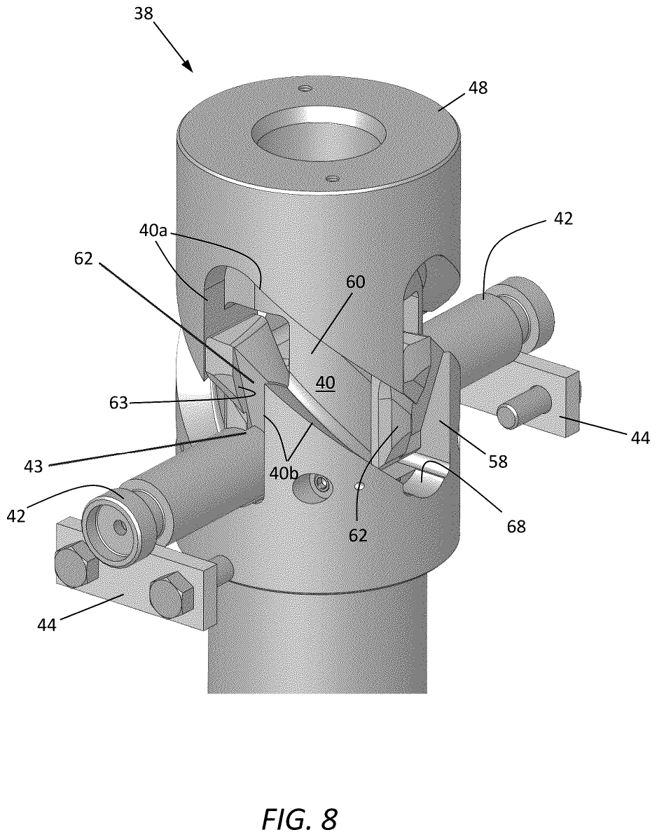

As best seen in FIG. 5, each pawl 62 is configured to rotate about a pivot connection 70 with the cam head 48 as the follower pin 42 engages the pawl 62 in an upward direction within the axial portion 58 of the cam path 40. The pawl 62 has a bottom end with a pin extending therethrough to form the pivot connection 70 with the cam head 48. A radially outer cam rail 72 at the top end of the pawl 62 is slanted at an angle to the longitudinal axis of the cam pin 38 and forms a portion of the lower cam surface 40b at the upper end of the slanted portion 60 of the cam path 40. The cam rail 72 extends radially outwardly into the axial portion 58 of the cam path 40 in its extended configuration. A lower surface of the cam rail 72 is beveled outwardly so that the end of the follower pin 42 will engage and push the top end of the pawl 62 to rotate inwardly about the pivot connection 70 as the cam follower pin 42 moves into the top end of the slanted portion 60 from the axial portion 58. FIG. 8 represents an alternative configuration of the follower pins 42 and pawls 62, in which each pawl 62 has a channel 63 engaging a complementary step 43 defined in the corresponding pin 42 for the intended purpose of minimizing wear between the pins 42 and the cam surfaces 40a and 40b within the axial portion 58.

In the embodiment of the pawls 62 shown in the drawings, the pawl 62 is represented as a spring-loaded pawl that is biased radially outwardly by a spring or similar biasing member 76 to the extended configuration. A spring seat 74 has a projection that extends radially inwardly from an upper portion of the main body of the pawl 62 and forms a seat for the biasing member 76, such as a pre-load coil spring that urges the pawl 62 to rotate radially outwardly about the pivot connection 70 to form the upper end of the slanted portion 60 of the cam path 40. Thus, when the follower pin 42 clears the cam rail 72 of the pawl 62 as it moves into the top end of the axial portion 58, the biasing member 76 urges the pawl 62 to pivot back out to the extended configuration shown in FIG. 5. In this position, the cam rail 72 prevents the follower pin 42 from traveling back down the axial portion 58 and only allows the follower pin 42 to travel downwardly along the slanted portion 60 to the bottom end of the next axial portion 60. Other configurations for allowing the pawls 62 to move the cam rail 72 radially in and out in response to the follower pins 42 could also be used. For one nonlimiting example, the pawls 62 could be configured to simply translate radially in and out along a radial track with a suitable spring to urge the pawls 62 radially outwardly. Other designs could also be used. In addition, the biasing member 76 is not necessarily limited to being a coil spring, but could be any other suitable arrangement that provides a biasing force against the pawls 62 for urging the pawls 62 into the radially locked out positions where the cam rails 72 are aligned to form the upper ends of the slanted portions 60 of the cam path 40.

To further help prevent the pin follower 42 from traveling back up the slanted portion 60 before the latch assembly 12 is fully indexed, the bottom end of the axial portion 58 may extend downwardly slightly beyond the path of the lower cam surface 40a to form a seat 68 for the cam follower 42 that is slightly recessed. However, due to the inclined orientation of the slanted portion 58 and the vertical orientation of the axial portion 60, the seat 68 does not need to be recessed in order to positively maintain the cam pin 38 in the indexed locked or unlocked position.

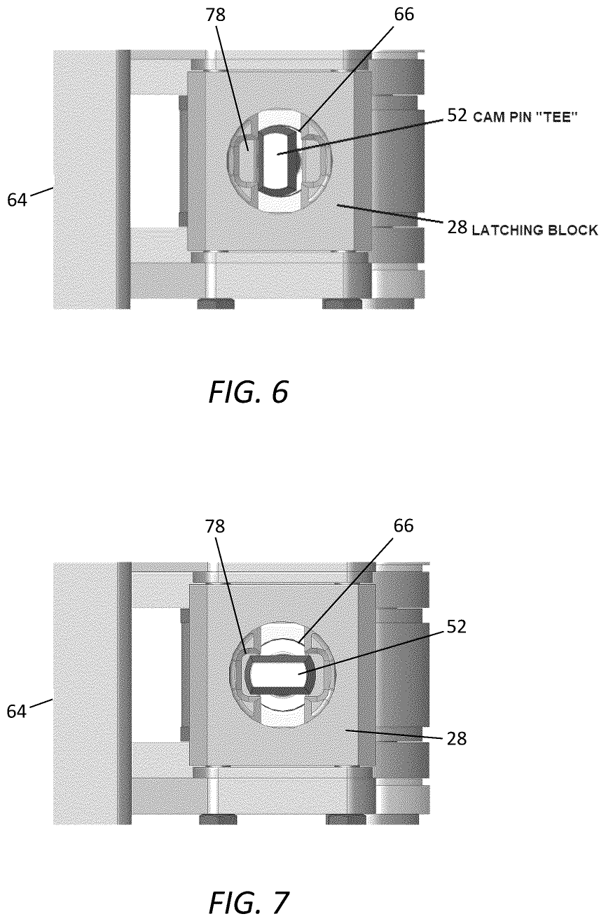

To cause the axial translation of the cam pin 38 within the bore 36 of the cam pin housing 30, the lower radial shoulder 54 engages a top surface of the latching block 28 when the scissors linkage 14 retracts and brings the cam pin 38 into engagement with the top surface of the latching block 28. As best seen in FIGS. 1A, 6 and 7, the latching block 28 is fixedly attached to an arm 64 extending laterally outwardly from the upper horizontal cross link 24 in the plane of the scissors linkage 14 to be aligned with and facing the latch assembly 12 when the scissors linkage 14 is in its retracted configuration. The latching block 28 includes a latch aperture 66 that receives the latching head 52 therein. The latch aperture 66 forms a slot with a lateral length longer than its lateral width to form a generally oblong shape that corresponds generally with the shape of the locking head 52. The locking head 52 can move up and/or down through the latch aperture 66 when the lateral axis of the locking head 52 is aligned with the long axis of the latch aperture 66 such that the length of the T-shaped end is parallel with the length of the slot of the latch aperture 66, as shown in FIG. 6. When the lateral axis of the locking head 52 is oriented at an angle to the long axis of the latch aperture 66, the locking tabs at the lateral ends of the locking head 52 engage long edges of the latch aperture 66 to lock the cam pin 38 to the latching block 28, as shown in FIG. 7.

Depending on the clearances between the outer periphery of the locking tabs of the locking head 52 and the inner peripheral edge of the latch aperture 66, the locking head 52 could theoretically engage the edges of the latch aperture 66 in intermediate angular positions between the parallel unlocked position shown in FIG. 6 and the orthogonal fully locked position shown in FIG. 7. This could be an unstable partial locking configuration and is generally undesirable. However, due to the design of the cam path 40 with the pawls 62, the cam pin 38 will always rotate 90° every time the cam pin 38 is indexed. Thus, the locking assembly 10 prevents partial locking of the cam pin 38 within the latching block 28. To further ensure positive locking of the cam pin 38 into the fully locked position, a recessed seat 78 may be formed in the underside of the latching block 28 facing away from the latch assembly 12 to nest the locking tabs when in the fully locked position. The recessed seat 78 can help prevent the cam pin 38 from rotating due to vibrations or other causes before the latch assembly 12 is fully indexed when a load is set down.

A cycle of successively locking and then unlocking the locking assembly 100 includes indexing the latch assembly 12 two times in succession. For example, the locking assembly 100 is unlocked when the coil lifting device 10 is lifting a load, such as a steel coil, ingot, stack, etc. To index the locking assembly 100 from the locked position to the unlocked position, the load is set down onto a support surface and the coil lifting device 10 is allowed to rest fully on the top of the load. When this happens, the latching block 28 engages the lower stepped shoulder 56 and pushes the cam pin 38 upwardly inside the bore 36 of the cam pin housing 30. This upward axial translation forces the follower pins 42 to travel down the slanted portions 60 of the cam path 40 into the seats 68 at the bottom ends of the axial portions 58. This movement advances the cam pin 38 a first time to rotate the locking head 52 a quarter turn from the unlocked position into the fully locked position with the locking tabs nested in the recessed seat 78 to lock the scissors linkage 14 in the retracted configuration. In the locked (retracted) configuration, the coil lifting device 10 can be lifted and moved to another load. When the coil lifting device 10 is lifted, the latching block 28 pulls away from the latch assembly 12 a short distance, pulling (or allowing gravity to pull) the cam pin 38 back down and raising the follower pins 42 up the axial portion 58 of the cam path 40, past the pawls 62, into the apex at the upper junction of the top end of the axial and slanted portions 58 and 60 without further rotating the cam pin 38. Due to the gravitation load on the cam pin 38, the follower pins 42 will remain at the top of the axial portions 58 in the locked position until the cam pin 38 is again pushed upwardly in the bore 36. Then, when the coil lifting device 10 is next lowered onto the next load, the latching block 28 again pushes the cam pin 38 upwardly in the bore 36 of the cam pin housing 30, causing the cam pin followers 42 to travel down the slanted portions 60 of the cam path 40 into the seat 68 at the next adjacent lower junction, thereby again rotating the cam pin 38 another quarter turn and advancing the locking head 52 from the locked position to the unlocked position. Then in the unlocked position, when the coil lifting device 10 is next lifted, the scissors linkage 14 can again extend, thereby causing the tongs 18 and 20 to again clamp onto a load therebetween. Thus, unlike previous designs, the cam pin 38 and the locking assembly 100 only allow the cam pin 38 to advance by rotating in a single angular direction around the cam path 40 rather than possibly being able to rotate in both “forward” and “reverse” angular directions. The shape of the cam path 40 and the spring-loaded pawls 62 both help prevent the cam pin 38 from rotating in the “reverse” direction. In addition, the saw-tooth shape of the cam path 40 helps ensure that the locking head 52 advances a complete 90° turn every time the coil lifting device 10 is indexed, thereby ensuring that the locking head 52 is either fully locked or fully unlocked, and preventing situations where the locking head 52 is in a partially locked state.

Although the embodiment shown in the drawings is designed to advance 90° between each successive locked and unlocked position, in other configurations, the latching block 28, latching head 52, and/or the cam path 40 could be configured to have successive locked and unlocked positions that are angularly offset at angles other than 90°. For example, the latch aperture 66 and/or the locking head 52 could be shaped to allow the locking positions to be less than 180° apart, such as at 90° intervals. In such an example, the cam path 40 could be modified to rotate the cam pin 38 only 45° with each indexing. Other angular subdivisions about the circle could also be used.

The locking assembly 100 is preferably capable of eliminating or at least reducing the risk of the false latch scenario that can occur in conventional coil lifting devices. In addition, the locking assembly 100 can be realized with a pre-assembled cam pin 38 as a “drop in” replacement for an existing cam pin, thereby making it easy to retrofit into existing conventional coil lifting devices. Thus, in some configurations, the locking assembly 100 could be used to replace a corresponding conventional locking assembly with little or no significant changes to the equipment. In some configurations, the cam pin 38 may be completely serviceable, and could be used in most common Heppenstal, Drafto, and Hunter lifts, as well as Mesta models of the same design, with a positive anti-reversing lock. Likewise, the locking assembly 100 and the cam pin 38 readily can be scaled to fit both larger and smaller models of coil lifting devices. In addition, the locking assembly 100 may be provided as a self-contained unit that requires no outside movements beyond the normal crane movements to index the cam pin 38 between the locked and unlocked positions.

The locking assembly 100 may in some arrangements maintain the same overall design envelope, strength, and basic operational characteristics of conventional locking assemblies. However, unlike conventional locking assemblies, the cam pin 38 reduces the “lift and lower” cycle to just one lift and one lower to complete an index between locked and unlocked positions, such as a typical 90-degree rotation between locked and unlocked positions. For directional bias (anti-reversing), the cam pin 38 uses the spring-loaded pawls 62 that only permit the cam pin 38 to rotate in one direction. This results in the Heppenstal lift being positively either locked or unlocked, but it cannot be falsely latched in an intermediate position.

The anti-reversing feed design of the cam pin 38 may be realized through the cam path 40 that only allows vertical operation of the cam pin 38 at each locked or unlocked index position, such as every 90 degrees, and the set of spring-loaded pawls 62 that are uni-directional in the rotation of the cam pin 38. This maintains the existing operation of the coil lifting device 10 to the crane operator, but as the lift and lower cycle is completed, the cam pin 38 cannot rotate backwards and unlock during transport.

As previously noted above, though the foregoing detailed description describes certain aspects of one or more particular embodiments of the invention, alternatives could be adopted by one skilled in the art. For example, the locking assembly 100 and its components could differ in appearance and construction from the embodiments described herein and shown in the drawings, functions of certain components of the locking assembly 100 could be performed by components of different construction but capable of a similar (though not necessarily equivalent) function, and various materials could be used in the fabrication of the locking assembly 100 and/or their components. As such, and again as was previously noted, it should be understood that the invention is not necessarily limited to any particular embodiment described herein or illustrated in the drawings.

1. A latch assembly for a locking assembly on a coil lifting device having a scissors linkage for clamping and unclamping a pair of tongs and carrying a latching block, the locking assembly comprising:
a cam pin housing comprising a bore;
a follower pin fixed to the cam pin housing and extending into the bore; and
a cam pin disposed within the bore, the cam pin being able to slide axially and rotationally within the bore, the cam pin further comprising:
a locking head disposed toward a bottom end of a main body;
a cam head disposed toward a top end of the main body;
a circumferential cam path extending continuously around an entire outer periphery of the cam head and slidably receiving the follower pin therein, the cam path comprising a plurality of successive saw-tooth sections, each saw-tooth section comprising an axial portion of the cam path aligned parallel to a longitudinal axis of the cam pin and a slanted portion of the cam path aligned at an angle to the longitudinal axis, wherein an upper end of each of the axial portion and the slanted portion of a saw-tooth section intersect with each other at an upper junction, and wherein a lower end of the slanted portion of one saw-tooth section intersects with a lower end of the axial portion of the next adjacent saw-tooth section at a lower junction; and
a retractable pawl extending into the cam path adjacent the upper junction, the retractable pawl forming at least a portion of the upper end of the slanted portion of the cam path in an extended configuration, the retractable pawl being configured to retract radially inwardly toward the longitudinal axis of the cam pin when the follower pin travels upwardly into and past the retractable pawl, wherein a biasing mechanism automatically urges the retractable pawl radially outwardly toward the extended configuration, and wherein the pawl prevents the follower pin from traveling downwardly along the axial portion from the upper junction when in the extended configuration.

2. The latch assembly of claim 1, wherein the circumferential cam path defines four saw-tooth sections, each saw-tooth section angularly spaced 90° from the adjacent saw-tooth sections, whereby the cam pin rotates 90° within the bore of the cam pin housing each time the cam pin is cycled axially up and down to shift the follower pin completely along one saw-tooth section of the cam path.

3. The latch assembly of claim 2, wherein one of the retractable pawl is disposed adjacent the upper junction of each saw-tooth section.

4. The latch assembly of claim 1, wherein the retractable pawl has a channel and the follower pin has a step that is engaged by and complementary to the channel.

5. The latch assembly of claim 1, wherein the pawl pivots about a pivot connection with the cam head, and wherein the biasing member urges the pawl to pivot radially outwardly around the pivot connection.

6. A cam pin for a locking assembly on a coil lifting device, the locking assembly having a cam pin housing for slidably receiving the cam pin and a latching block for latching to the cam pin, the cam pin comprising:
an elongate main body extending along a longitudinal axis between a cam head and a locking head for latching to the latching block;
a circumferential cam path extending continuously around an entire outer periphery of the cam head for slidably receiving a follower pin therein, the cam path comprising a plurality of successive saw-tooth sections, each saw-tooth section comprising an axial portion of the cam path aligned parallel to the longitudinal axis and a slanted portion of the cam path aligned at an angle to the longitudinal axis, wherein an upper end of each of the axial portion and the slanted portion of a saw-tooth section intersect with each other at an upper junction, and wherein a lower end of the slanted portion of one saw-tooth section intersects with a lower end of the axial portion of the next adjacent saw-tooth section at a lower junction; and
a retractable pawl extending into the cam path adjacent the upper junction, the retractable pawl forming at least a portion of the upper end of the slanted portion of the cam path in an extended configuration, the retractable pawl being configured to retract radially inwardly toward the longitudinal axis of the cam pin in response to a follower pin traveling upwardly into and past the retractable pawl, wherein a biasing mechanism automatically urges the pawl radially outwardly toward the extended configuration, and wherein the pawl is configured to prevent a follower pin from traveling downwardly along the axial portion from the upper junction when in the extended configuration.

7. The cam pin of claim 6, wherein the cam head is cylindrical, and wherein the circumferential cam path defines four saw-tooth sections, each saw-tooth section angularly spaced 90° from the adjacent saw-tooth sections so that the cam pin can rotate 90° within a bore of the cam pin housing each time the cam pin is cycled axially up and down within the bore to shift the follower pin completely along one saw-tooth section of the cam path.

8. The cam pin of claim 7, wherein a retractable pawl is disposed adjacent the upper junction of each saw-tooth section.

9. The cam pin of claim 6, wherein the retractable pawl has a channel and the follower pin has a step that is engaged by and complementary to the channel.

10. The cam pin of claim 6, wherein the pawl pivots about a pivot connection with the cam head, and wherein the biasing member urges the pawl to pivot radially outwardly around the pivot connection.

11. A coil lifting device comprising:
a scissors linkage that articulates from an extended configuration to a retracted configuration;
a pair of tongs coupled to the scissors linkage and configured to clamp and unclamp in response to extension and retraction of the scissors linkage; and
a locking assembly for automatically locking the scissors linkage in the retracted configuration, the locking assembly comprising:
a cam pin housing comprising a bore, the cam pin housing attached to a link of the scissors linkage;
a follower pin fixed to the cam pin housing and extending into the bore; and
a cam pin disposed within the bore, the cam pin being able to slide axially and rotationally within the bore, the cam pin further comprising:
a locking head disposed toward a bottom end of a main body;
a cam head disposed toward a top end of the main body;
a circumferential cam path extending continuously around an entire outer diameter of the cam head and slidably receiving the follower pin therein, the cam path comprising a plurality of successive saw-tooth sections, each saw-tooth section comprising an axial portion of the cam path aligned parallel to a longitudinal axis of the cam pin and a slanted portion of the cam path aligned at an angle to the longitudinal axis, wherein an upper end of each of the axial portion and the slanted portion of a saw-tooth section intersect with each other at an upper junction, and wherein a lower end of the slanted portion of one saw-tooth section intersects with a lower end of the axial portion of the next adjacent saw-tooth section at a lower junction;
a retractable pawl extending into the cam path adjacent the upper junction, the retractable pawl forming at least a portion of the upper end of the slanted portion of the cam path in an extended configuration, the retractable pawl being configured to retract radially inwardly toward the longitudinal axis of the cam pin when the follower pin travels upwardly into and past the retractable pawl, wherein a biasing mechanism automatically urges the retractable pawl radially outwardly toward the extended configuration, and wherein the retractable pawl prevents the follower pin from traveling downwardly along the axial portion from the upper junction when in the extended configuration; and
a latching block for latching to the cam pin, the latching block secured to another section of the scissors linkage to engage against the bottom end of the cam pin when the scissors linkage is in a retracted configuration and to disengage from the bottom end of the cam pin when the scissors linkage is in an extended configuration;
wherein, the locking head rotates from an unlocked position to a locked position to the latching block when the cam pin is indexed by raising away from and subsequently lowering back onto the latching block, and wherein the locking head rotates from the locked position to an unlocked position to the latching block the next time the cam pin indexed by raising away from and subsequently lowering back onto the latching block.

12. The coil lifting device of claim 11, wherein the circumferential cam path defines four saw-tooth sections, each saw-tooth section angularly spaced 90° from the adjacent saw-tooth sections, whereby the cam pin rotates 90° within the bore of the cam pin housing each time the cam pin is indexed axially up and down to shift the follower pin completely along one saw-tooth section of the cam path such that the locking head rotates 90° each time the cam pin is indexed.

13. The coil lifting device of claim 12, wherein a retractable pawl is disposed adjacent the upper junction of each saw-tooth section.

14. The coil lifting device of claim 11, wherein the retractable pawl has a channel and the follower pin has a step that is engaged by and complementary to the channel.

15. The coil lifting device of claim 11, wherein the pawl pivots about a pivot connection with the cam head, and wherein the biasing member urges the pawl to pivot radially outwardly around the pivot connection.

16. A method of operating a coil lifting device comprising the latch assembly of claim 1, the method comprising:
lowering the coil lifting device a first time, thereby rotating the cam pin a first time to a locked position;
raising the coil lifting device a first time with the cam pin remaining in the locked position;
lowering the coil lifting device a second time, thereby rotavating the cam pin a second time to an unlocked position; and
raising the coil lifting device a second time with the cam pin remaining in the unlocked position.

17. The method of claim 16, wherein the cam pin does not rotate either of the first or second times the coil lifting device are lifted.

18. The method of claim 16, wherein the retractable pawl retracts radially inwardly from the extended configuration in response to the follower pin traveling from the lower junction to the upper junction in the axial portion of the cam path when the coil lifting device is raised, and wherein the retractable pawl automatically shifts radially outwardly to the extended configuration after the follower pin moves past the retractable pawl into the upper junction.

19. The method of claim 18, wherein the retractable pawl in the extended configuration guides the follower pin from the upper junction along the slanted portion of the cam path toward the lower junction of the next adjacent saw-tooth section.

20. The method of claim 16, wherein the first time lowering and raising the coil lifting device indexes the cam pin a first 90° turn, and wherein the second time lowering and raising the coil lifting device indexes the cam pin a second 90° turn.

21. The method of claim 16, wherein the first and second rotations of the cam pin are in the same angular direction.
